(19) United States
(12) Patent Application Publication
(10) Pub. No.: US 2019/0209423 A1
(43) Pub. Date: Jul. 11, 2019

(54) REINFORCED MULTIPLE EXERCISE PLATFORM WITH INCLINATION CONTROL MEANS

(71) Applicant: Fernando Humberto MERCENARI URIBE, Mexico City (MX)

(72) Inventor: Fernando Humberto MERCENARI URIBE, Mexico City (MX)

(21) Appl. No.: 16/300,622

(22) PCT Filed: May 16, 2017
(86) PCT No.: PCT/MX2017/050007

§ 371 Date: Nov. 12, 2018

(30) Foreign Application Priority Data
May 27, 2016 (MX) MX/U/2016/000211

(51) Int. Cl. A61H 15/00; A63B 22/16; A63B 22/20

(52) U.S. Cl. CPC A61H 15/00; A63B 22/20; A63B 22/16

(57) ABSTRACT

A multiple exercise platform reinforced with a convex surface that has means to regulate the oscillatory movement thereof, which also has textured surfaces that provide massage to the user extremities and a mechanism for controlling the opening of collapsible wheels.

### FIELD OF THE INVENTION

The present invention relates to an improved multiple exercise platform and more particularly to a reinforced platform for the performance of multiple physical activities according to the operator relative position respect to a substantially convex surface and a semi-concave surface, which by means of a series of perforations and the use of running stops, allows varying the inclination degree of the routines performed and also has textured surfaces that provide massages to the user extremities.

### BACKGROUND OF THE INVENTION

Exercise platforms are useful devices that allow to carry out different routines without the need to resort to the use of other more complex exercise devices. Said platforms in most cases are substantially parallelepiped devices that have surfaces with supports for the extremities that allow carrying out common exercises with an improved degree of resistance and/or extension.

Many of these types of devices become necessary in physical training routines, since they allow not only to increase the level of intensity of the routine, but at the same time can avoid injuries by guiding the extremities and body of the user to correct positions to carry out each one of the planned exercises.

However, while it is true that these devices allow to carry out improved routines regarding to the same carried out without any support, many of them only serve for a specific type of exercise or in any case only allow training a specific muscle group.

Examples of this type of device are described in Utility Model CN 201200756 Y, which protects a table for Pilates that consists of a central frame with two circular flat surfaces that can independently rotate on their axis, having said surfaces a mechanism that allows move them away or bring them closer together to increase or decrease the effort of the exercise carried out. However, the device described in said Utility Model is only for training the lower extremities and only works as a modified support surface to allow the free rotation of the feet on the work surface.

U.S. Pat. No. 8,033,969 B2 protects an exercise apparatus comprising a main body and an oscillating part. Said main body is composed of a first base, a plurality of walls and a user area which is composed of a seat part and a bending part, said bending part being above the seat part when a user is sitting on said part of the seat. Said device allows carrying out routines for exercising the abdomen and upper extremities by adding a pair of resistance strings that are coupled to a pair of perforations located on the sides of the apparatus. Also, and due to the presence of the bending part, said device allows the user to stand on said surface to practice exercises that require control over the balance of the body. However, said device does not allow the execution of oscillation exercises at variable inclination angles neither great amplitude.

The patent application US 20070197360 A1, describes an exercise device for the improvement of stretching workouts and allows carrying out training routines that require curving body surfaces. Said device consists of a case with a concave surface covered with a soft material on which it is possible to carry out the training routines. Also, on the sides of said case, there are a pair of slots for the placement of elastic strips to increase the resistance of the exercises performed. However, the device is designed only to allow the performance of sit-ups or stretches and is not designed to allow the performance of oscillation routines or body balance training.

U.S. Pat. No. 5,584,786 protects a training case to modify the curvature of the back during sit-up routines. This case is placed in the curvature of the back to provide the user with a support that improves their posture during exercise; however, the training case described does not allow the performance of any other type of exercise routines.

The U.S. Pat. No. 5,330,399, protects an exercise board that is substantially a crescent shaped, with two pedals at its ends and a series of supports for the placement of a pair of strings that are taken by the user to exert greater strength on the exercise board. This device is used for balance training and extremity coordination. However, there is no way to control the inclination angle of the device and it lacks surfaces for other body parts of the user than its feet.

The U.S. Pat. No. 7,563,216 describes a device for performing exercises on the arms comprising a crescent-shaped surface with transverse tubulars to facilitate the operator grip. Said device also has modifications to facilitate the flexion of the user arms and for the latter to maintain an active control of his balance to maintain the center of gravity stable. Said device does not have surfaces for performing other types of routines and lacks supports to modify the grip regions thereof.

Finally, patent U.S. Pat. No. 83,632,445 protects an equipment for carrying out multiple exercise routines, said equipment consists of a case with a concave surface and a convex surface that can be used with both surfaces placed downwards. It also has slots for the placement of attachments that facilitate the performance of sit-up routines and resistance. The biggest advantage of this equipment lies in the fact that it allows to carry out training to improve the user balance and at the same time toning the operator extremities. On the other hand, the protected equipment includes a pair of stops which serve to prevent the uncontrolled oscillation of the concave surface. However, the described equipment only allows a single inclination degree since it does not have mechanisms for regulating the inclination degrees thereof and even when it has a rotating surface, said surface does not has means to regulate its rotation resistance.

The above mentioned devices lack the means to effectively regulate the inclination degree thereof during the execution of an exercise routine and, they do not allow to select between different inclination degrees. In addition to the above, current devices can not handle very large workloads, since they do not have reinforcement structures that allow them to withstand large workloads.

In view of the above problems, there is a need to provide a multiple exercise platform with reinforcement structures that allow it to meet the requirements of heavy loads, means for regulating the inclination of its oscillation, a system for controlled deployment of the opening of hidden elements and textured surfaces that provide massage to the user extremities.

### SUMMARY OF THE INVENTION

In order to overcome the disadvantages of the equipment and multiple exercises surfaces available, the present invention aims to provide a multiple exercise platform constituted by a convex surface and a semi-concave surface, with means that allow it to vary the inclination degree of the routines performed when the equipment is placed on the convex surface.

A particular object of the present invention is to provide a multiple exercise platform with an internal structure with reinforcements that increase the resistance of the equipment even in stress situations.

Another object of the present invention is to provide a multiple exercise platform with textured surfaces with projections that provide massage to the user extremities.

A further object of the present invention is to provide a multiple exercise platform with a mechanism for controlling the opening of collapsible wheels.

The above mentioned objects, as well as others and the advantages of the present invention, will become apparent from the following detailed description thereof.

### DESCRIPTION OF THE FIGURES OF THE INVENTION

FIG. 1 shows a top perspective view of the multiple exercise platform of the present invention with the concave surface (A) facing upwards.

FIG. 2 shows a top perspective view of the multiple exercise platform of the present invention with the semi-convex surface (B) facing upwards.

FIG. 3 shows a perspective view of the stop (2).

FIG. 4 shows a perspective view of one of the collapsible wheels (9).

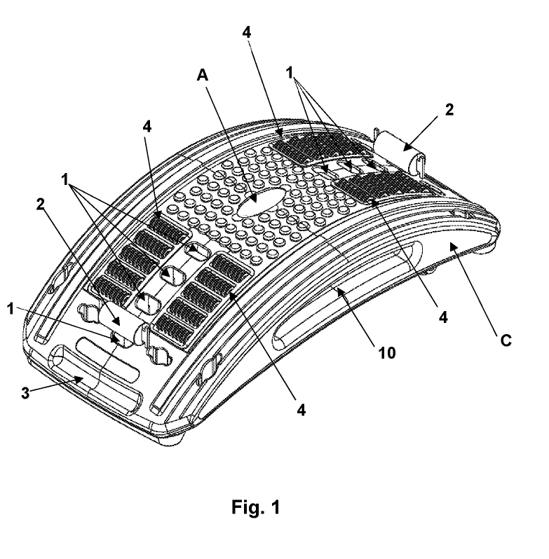

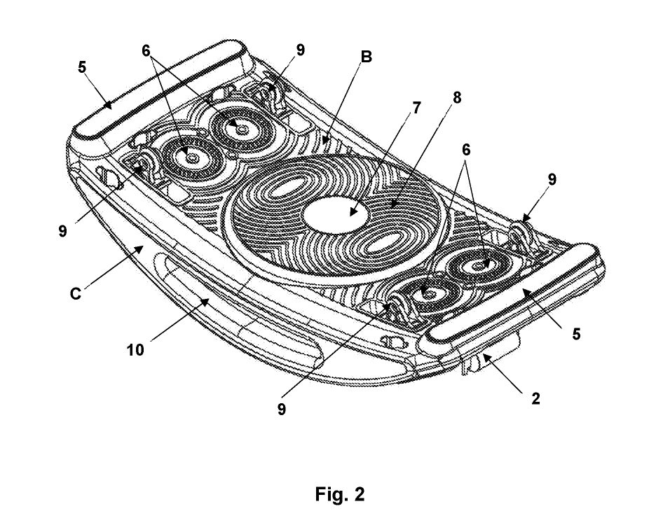

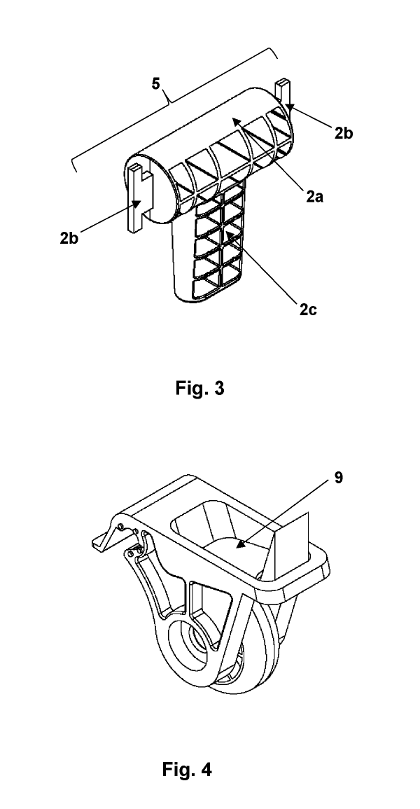

### DETAILED DESCRIPTION OF THE INVENTION

The present invention relates to a multiple exercise platform with an improved internal structure, means for regulating multiple inclination positions, a control system for opening hidden elements and textured surfaces that provide massage to the user extremities.

To achieve the foregoing, the multiple exercise platform of the present invention is comprised of a concave surface (A), a semi-convex surface (B) and a pair of sides (C); said structures are joined to each other by a structural reinforcement frame (not shown), which is constituted by a series of load surfaces that holds the above mentioned structure in place. The function of the above mentioned reinforcement frame is to distribute point loads throughout the assembly, thus allowing the multiple exercise platform to support large weights both of the user and in case the user loads additional weights, without the need to use thick materials in the construction of the concave surface (A), the semi-convex surface (B) and the side pair (C).

The concave surface (A), comprises a plurality of holes (1), equidistant from each other and located in two sets on both sides of said surface (A), each of said holes being designed to detachably receive a pair of stops (2), which are structures that in a preferred embodiment of the invention have a substantially “T” shape. The stops (2) in turn are formed by a cylinder (2a) with a pair of extensions (2b) and; a stem (2c) that serves as an anchoring structure. The stops (2) above described, are placed symmetrically along the plurality of holes (1) to serve with running stops that regulate the path and inclination of the surface (A) when it is placed on a firm support surface. In addition to the above, at the distal ends of the convex surface (A), there are a pair of grooves (3) that allow to hold the entire assembly to transport it safely.

In one embodiment of the present invention, the concave surface (A) has a high relief pattern that functions as a nonskid surface, which also provides massage when the multiple exercise platform is used with said concave surface upwards. On the other hand, the concave surface (A) may further comprise 4 groups of rollers (4), located equidistant from one another at the four ends of the concave surface (A), the groups of rollers (4) being preferably constituted by 5 independent rollers, which serve as sliding structures that provide massage to the user back and can also be textured to provide relaxation to the muscles. Said groups of rollers (4) in a preferred embodiment of the present invention, are separable elements from the concave surface (A), which are inserted in holes made for that purpose on said surface, in such a way that when the groups of rollers (4) are removed, the holes are blocked by covers with a high relief pattern that works as a nonskid surface and also provides massage when the multiple exercise platform is used with said concave surface upwards.

The semi-convex surface (B), comprises a pair of supports (5) located at both ends thereof and which serve as support structures when said surface (B) is placed on a support surface, preventing the whole assembly moves. Likewise, on said semi-convex surface (B), there are a pair of textured rest supports (6) that serve as nonskid support points for the placement of the user extremities during the oscillation routines are carried out by placing the multi-exercise platform with the concave surface (A) facing down. In addition to the above, the semi-convex surface (B) also comprises a rotating disc (7) in its middle part, for the execution of rotational exercise routines, having a nonskid textured surface (8) and; four collapsible wheels (9) located on the sides of the rest supports (6). Said collapsible wheels (9), in an embodiment of the present invention, are deployed using stops (2) acting as key stops, which when they are introduced into a closing and opening mechanism, allow the controlled deployment of the collapsible wheels (9).

Finally the sides (C), which cover the flanks of the multiple exercise platform, have a slot (10) in their middle portion, which is used by the user as a grip point to carry out the exercise routines; for this purpose when the multiple exercise platform is on the concave surface (A), the user can hold onto said grooves (10) to impel his body when the user sits on the rotating disc (7) or, if the multiple exercise platform is on the semi-convex surface (B), the user can hold onto the slots (10), to perform routines for lifting the lower extremities when the platform rests on the supports (2), or extension type exercises and abdomen flexion when the collapsible wheels (9) are deployed.

In one of the preferred embodiments of the present invention, the concave surface (A), the pair of supports (5) and the nonskid textured surface (8), have projections on the surfaces of said elements that act as structures that provide massage to the user body extremities, specifically at the user feet when using the platform without wearing footwear.

In another embodiment of the invention, the multiple exercise platform comprises means for graduating the resistance of the rotating disc (7) and optionally a quantizing device (not shown) for taking measurements such as the total number of oscillations of the platform, the inclination degree of the device and/or the number of rotations of the rotating disk (7). In this embodiment of the invention, the stop (2) can act as a key that regulates the strength of the resistance grading mechanism of the rotating disc (7).

The present invention has been described according to a preferred embodiment; however, it will be apparent to a technician with average knowledge in the matter, that modifications to the invention may be made, without departing from its spirit and scope.

1. A multiple exercise platform with a concave surface (A), a semi-convex surface (B) and a pair of sides (C), characterized in that it comprises:
a frame of structural reinforcement arranged to join the concave surface (A), the semi-convex surface (B) and the side pair (C) and distribute the point loads throughout the assembly; a plurality of holes (1) equidistant from each other, located in two sets on both sides of the concave surface (A), each of said holes being designed to detachably receive a pair of stops (2), which are placed symmetrically along the plurality of holes (1) to serve as running stops that regulate the travel and inclination of the surface (A); a pair of grooves (3) located at the distal ends of the convex surface (A) to hold the platform and be able to transport it; a pair of supports (5) located at both ends of the semi-convex surface (B) to serve as support structures; a pair of textured rest supports (6) arranged on the semi-convex surface (B) to serve as nonskid support points for the placement of the user extremities during the oscillation routines; a rotating disk (7) with a nonskid textured surface (8), located in the middle part of the semi-convex surface (B) for the execution of rotational exercise routines; four collapsible wheels (9) located on the sides of the rest supports (6) and; a groove (10) disposed in the middle portion of the sides (C), to serve as a grip point to carry out the exercise routines.

2. The multiple exercise platform according to claim 1, characterized in that the pair of stops (2), have a substantially “T” shape.

3. The multiple exercise platform according to claim 2, characterized in that the stops (2) comprise a cylinder (2a) with a pair of extensions (2b) and; a stem (2c) that serves as an anchoring structure.

4. The multiple exercise platform according to claim 1, characterized in that the concave surface (A) has a high relief pattern that functions as a nonskid surface and provides massage.

5. The multiple exercise platform according to claim 1, characterized in that the concave surface (A) further comprises 4 groups of rollers (4) located equidistant from each other at the four ends of said surface.

6. The multiple exercise platform according to claim 5, characterized in that the groups of rollers (4), are separable elements from the concave surface (A) that are inserted in holes made in said surface, said orifices being blocked by tops that have a high relief pattern that works as a nonskid surface and that also provides massage, when the groups of rollers (4) are removed.

7. The multiple exercise platform according to claim characterized in that each of the sets of rollers (4) are constituted by 5 independent rollers.

8. The multiple exercise platform according to claim 1, characterized in that the collapsible wheels (9) are deployed in a controlled manner by introducing the stops (2) in a closing and opening mechanism.

9. The multiple exercise platform according to claim 1, characterized in that the concave surface (A), the pair of supports (5) and the nonskid textured surface (8), have projections on the surfaces of said elements that function as structures that provide massage to the user body extremities.

10. The multiple exercise platform according to claim 1, characterized in that the multiple exercise platform comprises means for graduating the resistance of the rotating disc (7).

11. The multiple exercise platform according to claim 10, characterized in that the means for graduating the resistance of the rotating disc (7) is a resistance grading mechanism that is controlled with the stop (2).

12. The multiple exercise platform according to claim 1, characterized in that it comprises a quantifying device for taking measurements such as the total number of oscillations of the platform, the inclination degree of the device and/or the number of rotations of the rotating disk (9).

13. The multiple exercise platform according to claim 6, characterized in that each of the sets of rollers (4) are constituted by 5 independent rollers.
